(19) United States
(12) Patent Application Publication
(10) Pub. No.: US 2015/0198859 A1
(43) Pub. Date: Jul. 16, 2015

(54) SIMPLIFIED EXTINCTION RATIO CONTROL FOR MULTIPLE MACH-ZEHNDER INTERFEROMETER MODULATORS

(71) Applicant: ACACIA COMMUNICATIONS INC., Maynard, MA (US)

(72) Inventor: Long CHEN, MAYNARD, MA (US)

(21) Appl. No.: 14/103,674

(22) Filed: Dec. 11, 2013

Related U.S. Application Data
(60) Provisional application No. 61/735,721, filed on Dec. 11, 2012.

(51) Int. Cl. G02F 1/225

(52) U.S. Cl. CPC G02F 1/2257; G02F 2001/212

(57) ABSTRACT

Disclosed herein are methods, structures, apparatus and devices that improve the control and/or controllability of a group of Mach-Zehnder Interferometer modulators. Advantageously, such control may be implemented with optical tuning elements shared among all of the modulators, or with separate optical tuning elements operated through the effect of a set of common signals. Accordingly implementations according to one aspect of the present disclosure provides a significantly simplified configuration—where the extinction ratios of all modulators within the group are controlled jointly—in sharp contrast to those configuration(s) wherein all modulators are individually controlled.

### CROSS REFERENCE TO RELATED APPLICATIONS

This application claims the benefit of U.S. Provisional Patent Application Ser. No. 61/735,721 filed Dec. 11, 2012 which is incorporated by reference in its entirety as if set forth at length herein.

### TECHNICAL FIELD

This disclosure relates generally to optical communications. More particularly, this disclosure pertains to techniques, methods, apparatus, structures and materials pertaining to the joint control of a group of Mach-Zehnder Interferometer (MZI) modulators.

### BACKGROUND

Contemporary optical communications and other photonic systems make extensive use of optical modulators comprising controllable Mach-Zhender Interferometers. Accordingly, techniques, methods, apparatus and structures that improve the control and/or controllability would represent a welcome addition to the art.

### SUMMARY

An advance in the art is made according to an aspect of the present disclosure directed to techniques, methods, apparatus, structures and materials that improve the control and/or controllability of a group of Mach-Zehnder Interferometer modulators. Advantageously, such control may be implemented with optical tuning elements shared among all of the modulators, or with separate optical tuning elements operated through the effect of a set of common signals.

Accordingly implementations according to one aspect of the present disclosure provides a significantly simplified configuration—where the extinction ratios of all modulators within the group are controlled jointly—in sharp contrast to those configuration(s) wherein all modulators are individually controlled.

Accordingly, a method according to the present disclosure advantageously controls the operation of a group of Mach-Zehnder Interferometer (MZI) modulators, wherein the group of MZI modulators have a common input and a common output by providing and optically connecting a single tunable splitter to an input stage of the group of MZI modulators, wherein two output branches of the tunable splitter are directed to subsequent stages of fixed splitting, such that outputs from the subsequent stages are routed to form the group MZI modulators, each individual modulator comprising the group having a top arm and a bottom arm, and configured such that the top arm of each modulator in the group is optically connected to the one of the tunable splitter output branches, while the bottom arm of each modulator is optically connected to the other one of the tunable splitter output branches.

Alternatively, the present disclosure is directed to optical structures exhibiting a simplified extinction ratio control for multiple Mach-Zehnder Interferometer (MZI) modulators wherein a plurality of MZI modulators are configured in parallel such that they share a common input and a common output, wherein each one of said plurality of MZI modulators includes a tunable power splitter and said optical structure configured such that a single common control signal drives all of the power splitters. Alternatives to these structures may advantageously include a number of variable optical attenuators, one in each arm of the MZI modulators, which in turn are controlled through the effect of a single, common control signal.

### BRIEF DESCRIPTION OF THE DRAWING

A more complete understanding of the present disclosure may be realized by reference to the accompanying drawings in which:

FIGS. 1(a) and 1(b) show schematic illustrations of controlling the extinction ratio of an individual MZI modulator including (a) tunable power splitter used in the splitter and/or combiner to adjust the power imbalance between the two arms, and (b) variable optical attenuators used in both arms of the MZI to adjust the power imbalance between the two arms;

FIGS. 2(a) and 2(b) show schematic illustrations of multiple MZI modulators integrated in a single device including: (a) polarization-multiplexed nested modulators for advanced modulation formats, and (b) parallel modulators for parallel optical interconnects according to the present disclosure;

FIGS. 3(a) and 3(b) show schematic illustrations of an exemplary silicon carrier depletion MZI modulator including: (a) wherein doping illustrated with dashed boxes creates two diodes in the two arms that are mirror images of each other and due to symmetry, both arms have the same absorption loss due to the p- and n-doped regions; and (b) wherein misalignment in fabrication shifts the diode placement with respect to the waveguides such that since p- and n-doped regions can have different absorption coefficients, the two arms may exhibit different losses, which degrades the extinction ratio of the modulator according to the present disclosure;

FIGS. 4(a) and 4(b) show schematic illustrations of exemplary joint extinction ratio control of all modulators using shared optical tuning elements, including: (a) a tunable power splitter, and (b) variable optical attenuators according to the present disclosure; and

FIGS. 5(a) and 5(b) show schematic illustrations of exemplary joint extinction ratio control of all modulators using separate optical tuning elements wherein the elements are operated by the same control signals including: (a) four tunable power splitters for the four MZI modulators are controlled by one signal; and (b) four variable optical attenuators for four top arms and four variable optical attenuators for four bottom arms are controlled by one signal respectively, according to the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not be shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, it is known that Mach-Zehnder Interferometer (MZI) modulators are widely used in optical communications. Known further is the fact that an extinction ratio of such modulators, i.e., the ratio of power levels when the modulator is at states of high transmission and low transmission respectively, is an important characteristic. The extinction ratio is affected by many aspects of the MZI, including the splitting ratios of a power splitter and combiner within the MZI structure itself, the optical loss difference between the two arms of the MZI, and optical amplitude change in the arms in response to the driving signals, etc. As will be readily appreciated by those skilled in the art, many of these factors are related to imperfections in fabrications, which in turn may cause large variation in the extinction ratios across different samples.

In many applications, a high extinction ratio is desirable. By way of specific example, for an on-off-keying (OOK) modulation, a higher extinction ratio—in general - improves the power sensitivity at optical receivers.

The extinction ratio is also related to transient characteristics of the modulated signal, and a poor extinction ratio may result in large modulation chirp. For advanced modulation formats such as QPSK and QAM, this causes distortions in modulation constellations.

In certain other applications a lower extinction ratio may be preferred, so that an intentional, negative chirp that may counterbalance dispersion effects in optical fibers thereby resulting in a better receiver sensitivity as compared to a chirp-free modulation. The optimal chirp value varies, and depends on the link dispersion and can be adjusted through the extinction ratio. Accordingly, the post-fabrication control of extinction ratios—either to improve the extinction ratios to a sufficiently high level or to tune the extinction ratios to appropriate values optimized for certain fiber transmission.

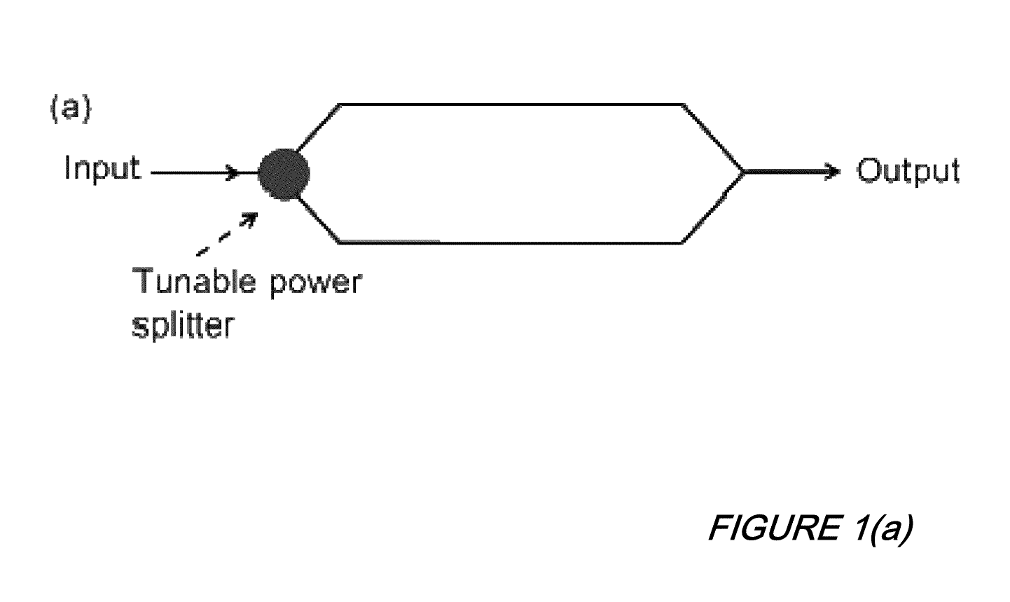

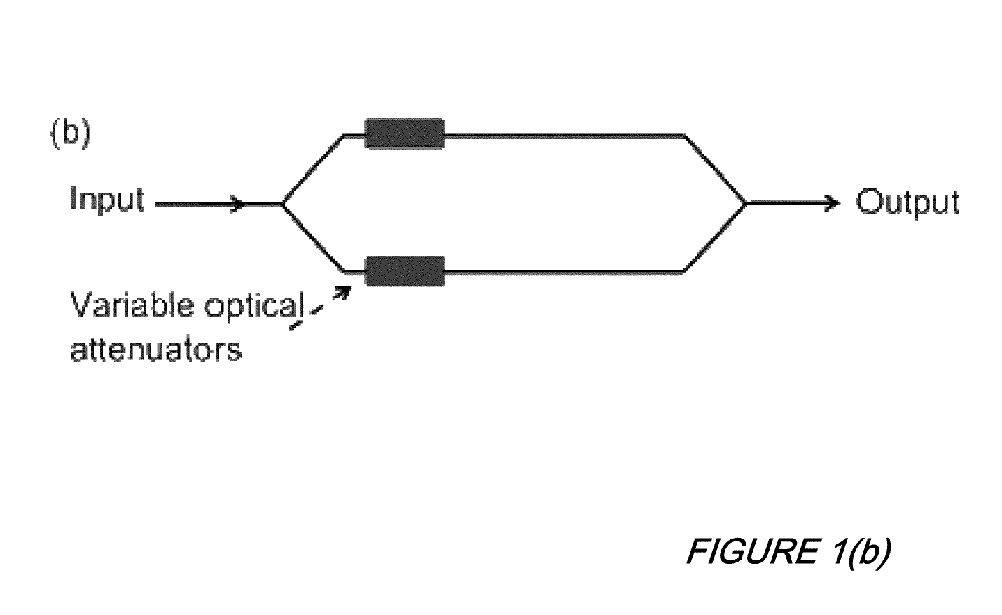

The post-fabrication control of the extinction ratio of an individual MZI modulator can be accomplished through a variety of methods. FIGS. 1(a) and 1(b) show schematics for two examples. In FIG. 1(a), a tunable optical power coupler at a splitter and/or combiner of the MZI to adjust the power imbalance. In FIG. 1(b), a variable optical attenuator (VOA) positioned in one or both arms of the MZI such that the arm exhibiting a higher optical power may be attenuated to match the other arm exhibiting a lower optical power.

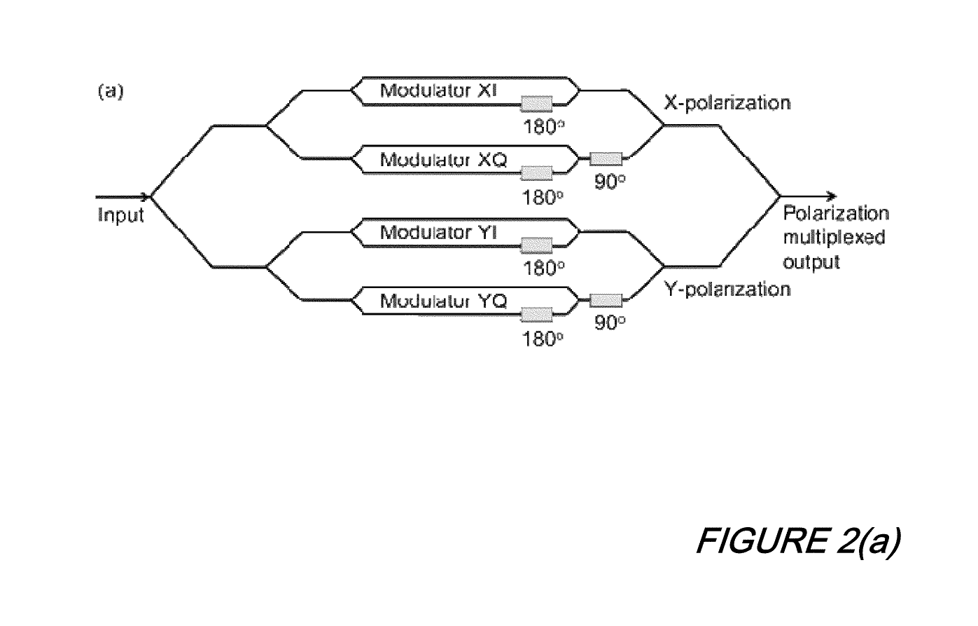

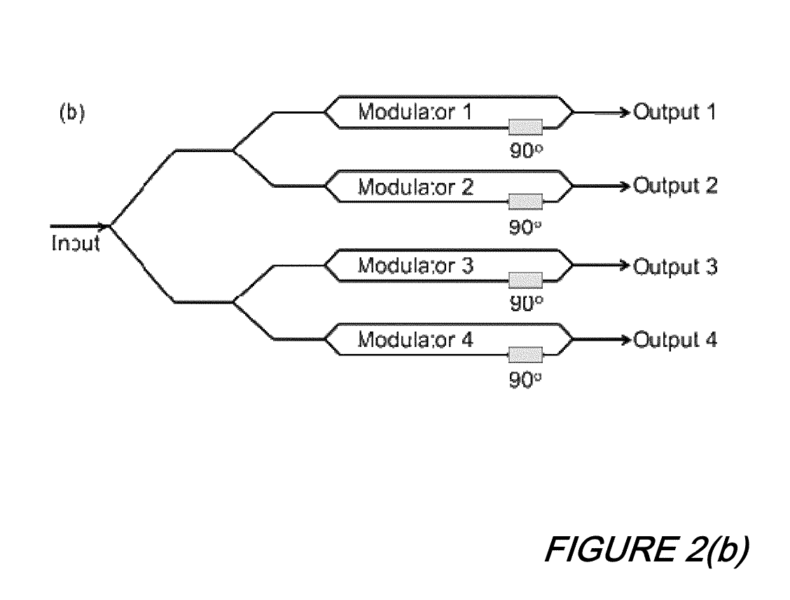

In certain applications extinction ratio control is required for a group of similar MZI modulators integrated together. For example, to obtain a polarization-multiplexed QPSK modulation format, four MZI modulators are used together as illustrated schematically in FIG. 2(a). In another example, as illustrated in FIG. 2(b), a group of MZI modulators are arranged in parallel, to generate a data stream for parallel optical channels.

As depicted therein, inputs are connected to a single laser source and outputs are connected to—for example—an array of optical fibers in a fiber ribbon. As should be noted, the number of parallel modulators can be 4, 8, 12, or even higher (an example of 4 is shown here). In both application examples shown in FIG. 2(a) and FIG. 2(b), the extinction ratio requirements are in general similar for all modulators within each group and therefore similar controls may be required for all modulators within each group.

One approach to controlling extinction ratios of such MZI modulator groups is to individually control each modulator within the group. For example, a tunable optical power splitter may be added to each MZI modulator, as shown in FIG. 2(a) for the nested modulators. Alternatively, variable optical attenuators can be added to each arm of the MZI modulators, as shown in FIG. 2(b).

As may be understood and with reference to FIG. 2(a) and FIG. 2(b), each tunable power splitter or variable optical attenuator is controlled separately to obtain a desired extinction ratio. One drawback to such a configuration and operation is that the number of controls required scales linearly with the number of modulators within the group, thereby adding significant the complexity of the overall system—especially when the number of modulators is large.

With this infirmity in mind, we note that one aspect of the present disclosure provides a significantly simplified configuration—where the extinction ratios of all modulators within the group are controlled jointly—in sharp contrast to configuration(s) wherein all modulators are individually controlled.

We recognize that in many circumstances the extinction ratios of all modulators within a group have similar characteristics (i.e., their deviation from the desired target is similar) and joint control is therefore applicable. One such example is a silicon carrier-depletion MZI modulator wherein the extinction ratio is affected by fabrication imperfections.

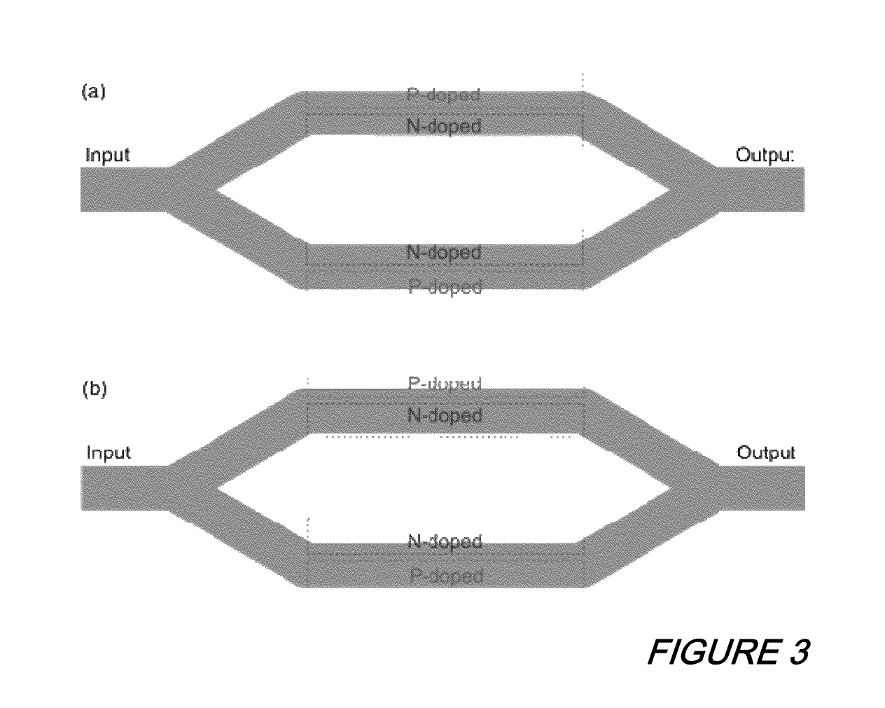

Generally, silicon p-n diodes are formed within MZI arm waveguides in multiple steps of ion implantation through windows defined by lithography (indicated by the dashed boxes in FIGS. 3(a) and 3(b)). Electrical modulation of the diodes induces change in the waveguide optical properties, which results in optical modulation.

With continued reference to FIGS. 3(a) and 3(b), there is shown in schematic form an example of a MZI modulator based on silicon carrier-depletion. In FIG. 3(a), a design target where the doping illustrated with the dashed boxes creates two diodes in the two arms that are mirror images of each other. Due to the symmetry, both arms have the same absorption loss due to the p- and n-doped regions. In FIG. 3(b) misalignment in fabrication shifts the diode placement with respect to the waveguides. Since p- and n-doped regions can have different absorption coefficients, the two arms can have different losses, which degrade the extinction ratio of the modulator.

Doped region also induce free-carrier absorption, which can be very different between the p- and n-doped regions due to different concentrations of electrons and holes and their difference in absorption cross-sections. When the two arms are designed with proper mirror symmetry, as indicated in FIG. 3(a), both arms exhibit the same absorption loss due to the doped regions. However, if the implantation steps are misaligned with respect to the waveguides (typically with an accuracy of around +/−100 nm limited by fabrication), the two diodes may exhibit different positions with respect to the two waveguides—i.e., they may be not symmetric with respect to the arm axis.

An example showing the result of such misalignment is shown schematically in FIG. 3(b), where the diodes are shown shifted upward with respect to the waveguides as compared to the design target. Such misalignment can have significant consequences for two reasons. First, the lateral width of the waveguides is typically quite small (around 500 nm) to maximize the modulation efficiency, so a misalignment level of up to +/−100 nm represents a significant change in the diode placement with respect to the waveguide optical mode.

Second, the absorption coefficients in the p- and n-doped regions may be very different depending on the design. For example, in some cases, the n-doped region has a much higher carrier concentration and its absorption coefficient is more than double that of the p-doped region. Therefore, any misalignment may result in significant power imbalance between the two arms and considerably degrade the extinction ratio of the modulator. Additionally, fabrication misalignment is largely random from exposure to exposure, so it is difficult to predict and compensate by design.

Post-fabrication tuning, using methods such as those discussed with respect to FIG. 1, is usually needed when stringent specifications on extinction ratios are required. However, within each exposure reticle all devices experience the same misalignment and should have similar extinction ratios, which allows us to jointly control the extinction ratios for all modulators within the group as compared to the methods of individual control of each modulator.

With these principles in mind, we may now describe the joint control of the extinction ratios of all modulators within a group—according to an aspect of the present disclosure.

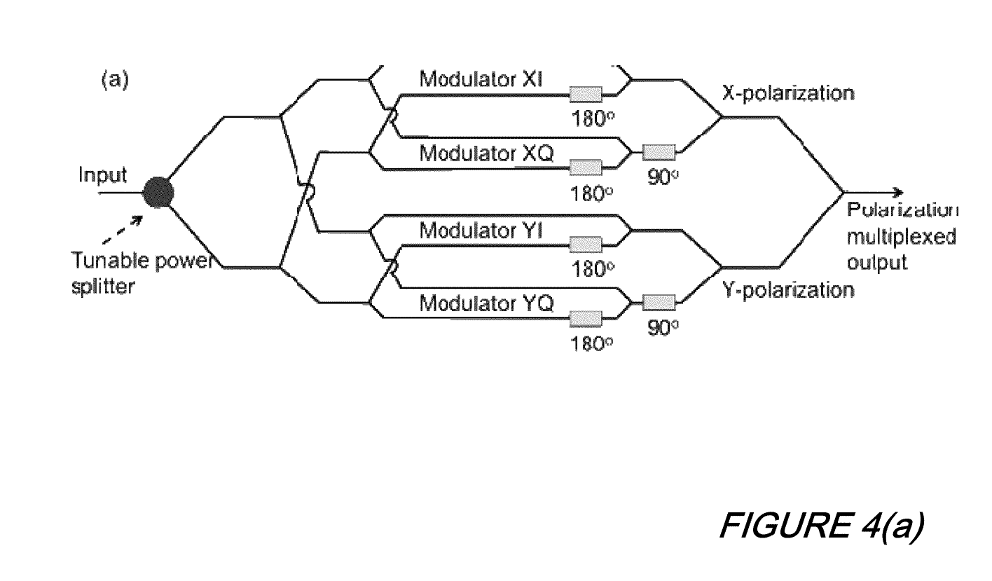

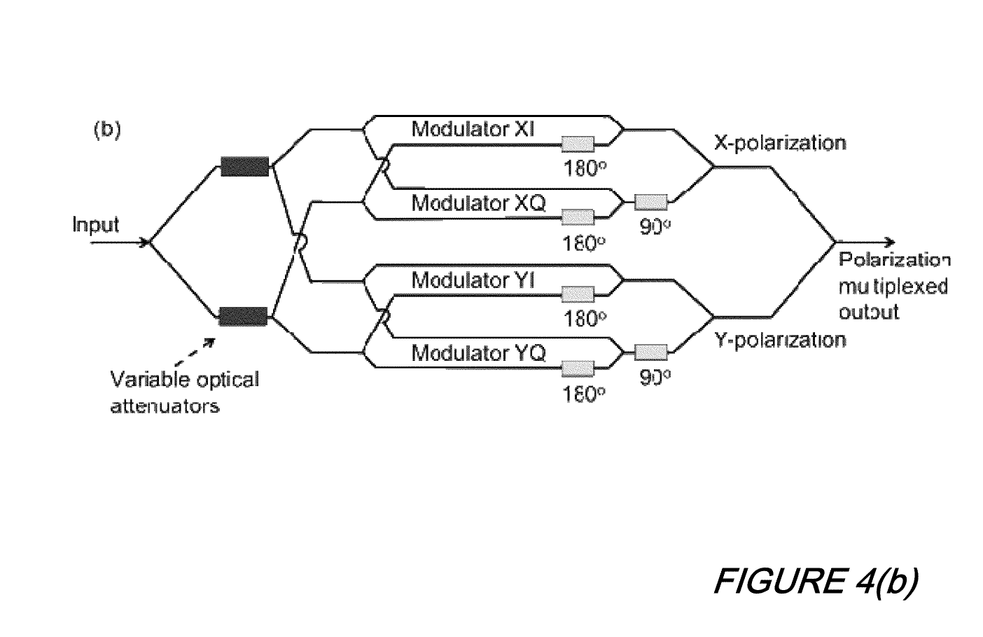

FIG. 4(a) and FIG. 4(b) shows in schematic form, two examples of joint extinction ratio control of all modulators using shared optical tuning elements, including: (a) a tunable power splitter, and (b) variable optical attenuators, respectively. With reference to those FIGS. 4(a) and 4(b), a first approach of joint control is to share the same optical tuning elements among all modulators for the polarization-multiplexed nested modulator application described previously.

In FIG. 4(a), a single tuning element namely, a tunable power splitter is inserted into the input stage of the MZI. The two output branches of the tunable splitter have two subsequent stages of fixed splitting, and the eight branches are routed to form four modulators. The routing is done in such a way that the top arms of the four MZI modulators are all optically connected to the top branch of the tunable power splitter, and the bottom arms of the four MZI modulators are all optically connected to the bottom branch of the tunable power splitter.

If there exists a difference in absorption loss between the top arms and the bottom arms (as shown in FIG. 3(b)), then a proper adjustment on the tunable power splitter can simultaneously compensate for the power imbalances of all four modulators.

FIG. 4(b) shows an example of using two variable optical attenuators after the first splitter instead of the tunable power splitter. Here one variable optical attenuator controls all top arms of the four modulators, and the other controls all bottom arms of the four modulators.

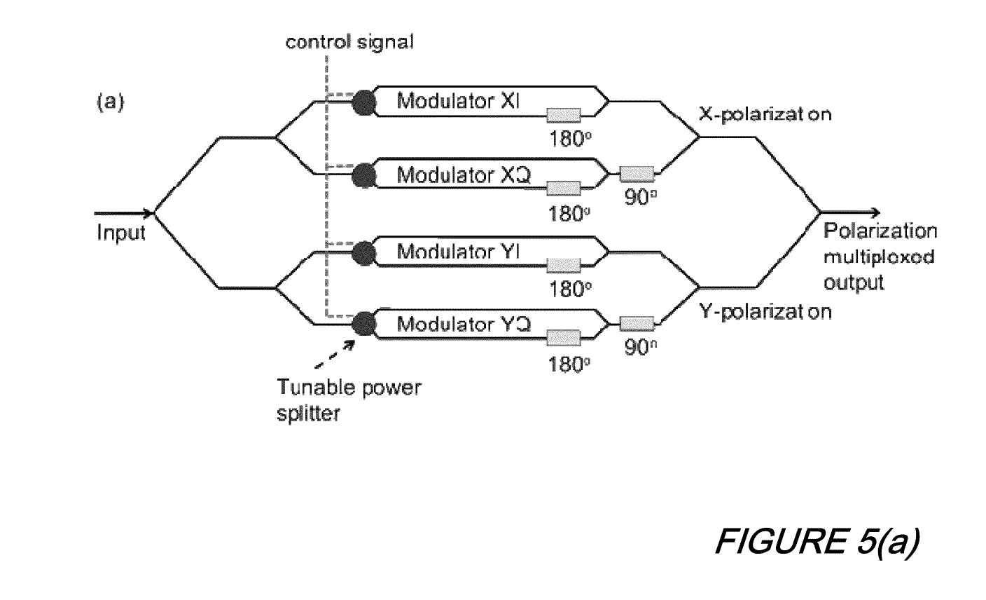

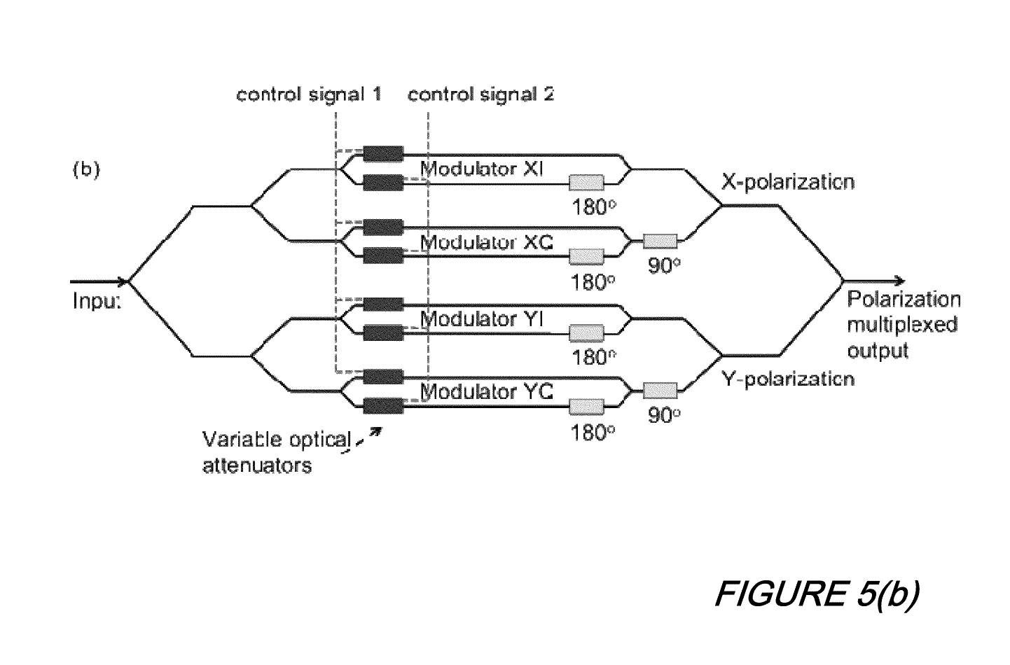

Another approach to joint control according to the present disclosure is to provide separate optical tuning elements among all modulators, wherein these tuning elements tied (optically/mechanically) to the same control signals. FIG. 5(a) and FIG. 5(b) show examples of joint extinction ratio control of all modulators using separate optical tuning elements wherein the elements are tied to the same control signals. In FIG. 5(a) four tunable power splitters for four MZI modulators are controlled by one signal. In FIG. 5(b) the four variable optical attenuators for four top arms and the four variable optical attenuators for the four bottom arms are controlled by one signal, respectively.

FIG. 5(a) shows the configuration that uses a tunable power splitter for each MZI modulator, wherein the four tunable power splitters are controlled by the same signal. FIG. 5(b) shows the configuration that uses two variable optical attenuators for each MZI modulator. The four attenuators for the top arms are controlled by the same signal, and the four attenuators for the bottom arms are controlled essentially by the second signal.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A method for controlling the operation of a group of Mach-Zehnder Interferometer (MZI) modulators, said group of MZI modulators having a common input and a common output, said method comprising:
providing and optically connecting a single tunable splitter to an input stage of the group of MZI modulators, wherein two output branches of the tunable splitter are directed to subsequent stages of fixed splitting, such that outputs from the subsequent stages are routed to form the group MZI modulators, each individual modulator comprising the group having a top arm and a bottom arm, and configured such that the top arm of each modulator in the group is optically connected to the one of the tunable splitter output branches, while the bottom arm of each modulator is optically connected to the other one of the tunable splitter output branches.

2. An optical structure exhibiting a simplified extinction ratio control for multiple Mach-Zehnder Interferometer (MZI) modulators comprising:
a plurality of MZI modulators configured in parallel such that they share a common input and a common output;
wherein each one of said plurality of MZI modulators includes a tunable power splitter;
said optical structure configured such that a single common control signal drives all of the power splitters
